(19) United States
(12) Patent Application Publication
(10) Pub. No.: US 2008/0138701 A1
(43) Pub. Date: Jun. 12, 2008

(54) BATTERY-INTEGRATED SEMICONDUCTOR MODULE AND METHOD FOR PRODUCING THE SAME

(75) Inventors: Takashi Kuboki, Tokyo (JP); Takashi Kishi, Yokosuka-Shi (JP); Yasuyuki Hotta, Tokyo (JP); Satoshi Mikoshiba, Yamato-Shi (JP); Tomoko Eguchi, Tokyo (JP); Tsuyoshi Kobayashi, Kawasaki-Shi (JP)

Correspondence Address: OBLON, SPIVAK, MCCLELLAND MAIER & NEUSTADT, P.C., 1940 DUKE STREET, ALEXANDRIA, VA, 22314, US

(73) Assignee: KABUSHIKI KAISHA TOSHIBA, Tokyo (JP)

(21) Appl. No.: 11/843,956

(22) Filed: Aug. 23, 2007

(30) Foreign Application Priority Data
Dec. 8, 2006 (JP) 2006-332341

(51) Int. Cl. H01M 14/00; H01M 2/14

(52) U.S. Cl. 429/129; 29/623.2

(57) ABSTRACT

It is made possible to provide a battery-integrated semiconductor module containing a small built-in battery having satisfactory output characteristics. A battery-integrated semiconductor module includes: an insulating substrate; a semiconductor device provided on the insulating substrate; a nonaqueous electrolyte battery for driving the semiconductor device, which is provided in and/or on the insulating substrate and comprises a positive electrode, a negative electrode, a separator for separating the positive electrode and the negative electrode from each other, and a nonaqueous electrolyte containing an ionic liquid as a main component, with which the positive electrode, the negative electrode, and the separator are impregnated; and a sealing resin provided to cover the semiconductor device and the nonaqueous electrolyte battery, wherein any one of the positive electrode, the negative electrode, and the separator is in contact with the insulating substrate and the sealing resin.

### CROSS-REFERENCE TO RELATED APPLICATION

This application is based upon and claims the benefit of priority from prior Japanese Patent Application No. 2006-332341 filed on Dec. 8, 2006 in Japan, the entire contents of which are incorporated herein by reference.

### BACKGROUND OF THE INVENTION

1. Field of the Invention

The present invention relates to a battery-integrated semiconductor module including a semiconductor device and a power supply for driving the semiconductor device, and to a method for producing the same.

2. Related Art

In recent years, studies have been made to develop semiconductor modules such as RFID (Radio Frequency IDentification) tags which can perform desired functions in the form of one-chip. These tags are divided into two types according to whether they have a built-in power supply or not. In the case of a tag not having a built-in power supply, it is necessary to supply electric power via wire or wirelessly to a circuit built in the tag when the tag is used. In the case of supplying electric power via wire, it is necessary to connect a connector or a lead wire to each tag, which makes it difficult to collect information from a plurality of tags. In the case of supplying electric power wirelessly, electric power is generated inside the tag by, for example, electromagnetic induction when the tag is used. In this case, the efficiency of generating electric power is significantly lowered when the distance between the tag and an external power supply device is long, which makes it difficult to collect information from a plurality of tags in a short time.

On the other hand, in the case of a tag having a built-in power supply, the strength of a signal transmitted from the tag is strong, which makes it possible to collect information from a plurality of remote tags in a short time. However, the volume of such a tag having a built-in power supply becomes larger by the volume of the power supply. For this reason, there is a demand for a smaller built-in power supply.

As a power supply to be built in a tag, a battery, a capacitor, or the like can be used. It is generally believed that a battery is preferable from the viewpoint of less capacity loss. Examples of a small battery generally used include a coin-type battery and a laminate-type battery. However, both the batteries need space for sealing, which decreases the capacity of the battery mountable in given space. For this reason, it is difficult to mount such a battery in a small semiconductor module.

Meanwhile, there is known a semiconductor device having a structure in which an IC chip is mounted on the surface of a battery (see, for example, JP-A 2005-286011 (KOKAI)). However, as described above, since such a semiconductor device has a structure, in which an IC chip is mounted on the surface of a battery, it is impossible to downsizing of the battery.

Further, a technique for directly forming a battery module on a substrate by, for example, sputtering has also been studied in recent years. However, in the case of using such a technique, a usable electrolyte is limited to a solid electrolyte, which causes the necessity to reduce the thickness of a layer of an electrode active material. For this reason, it is impossible to achieve a sufficient discharge capacity per unit area of electrode. In addition, the contact between the solid electrolyte and the electrode active material is poor and the lithium ion conductivity of the solid electrolyte is low, which makes it impossible to achieve satisfactory output characteristics during discharge.

### SUMMARY OF THE INVENTION

The present invention has been made in view of these circumstances, and an object thereof is to provide a battery-integrated semiconductor module containing a small built-in battery having satisfactory output characteristics and a method for producing the same.

A battery-integrated semiconductor module according to a first aspect of the present invention includes: an insulating substrate; a semiconductor device provided on the insulating substrate; a nonaqueous electrolyte battery for driving the semiconductor device, which is provided in and/or on the insulating substrate and comprises a positive electrode, a negative electrode, a separator for separating the positive electrode and the negative electrode from each other, and a nonaqueous electrolyte containing an ionic liquid as a main component, with which the positive electrode, the negative electrode, and the separator are impregnated; and a sealing resin provided to cover the semiconductor device and the nonaqueous electrolyte battery, wherein any one of the positive electrode, the negative electrode, and the separator is in contact with the insulating substrate and the sealing resin.

A method for producing a battery-integrated semiconductor module according to a second aspect of the present invention includes: forming a semiconductor device on an insulating substrate; forming a nonaqueous electrolyte battery by laminating a positive electrode, a negative electrode, and a separator for separating the positive electrode and the negative electrode from each other in and/or on the insulating substrate and pouring a nonaqueous electrolyte containing an ionic liquid as a main component onto the positive electrode, the negative electrode, and the separator to impregnate the positive electrode, the negative electrode, and the separator with the nonaqueous electrolyte; and sealing the semiconductor device and the nonaqueous electrolyte battery with a resin, wherein the nonaqueous electrolyte is in contact with the insulating substrate and the resin via any one of the positive electrode, the negative electrode, and the separator.

### BRIEF DESCRIPTION OF THE DRAWINGS

FIG. 1A is a cross-sectional view of a battery-integrated semiconductor module according to an embodiment;

FIG. 1B is a top view of the battery-integrated semiconductor module according to the embodiment, from which a resin has been removed;

FIG. 2A is a cross-sectional view of a battery-integrated semiconductor module according to a first modification;

FIG. 2B is a cross-sectional view of a battery-integrated semiconductor module according to a second modification;

FIG. 2C is a cross-sectional view of a battery-integrated semiconductor module according to a third modification;

FIG. 2D is a cross-sectional view of a battery-integrated semiconductor module according to a fourth modification;

FIG. 3A is a cross-sectional view of a battery-integrated semiconductor module according to a fifth modification;

FIG. 3B is a cross-sectional view of a battery-integrated semiconductor module according to a sixth modification;

FIG. 3C is a cross-sectional view of a battery-integrated semiconductor module according to a seventh modification;

FIG. 3D is a cross-sectional view of a battery-integrated semiconductor module according to a eighth modification;

FIG. 4A is a cross-sectional view which shows one step of a method for producing a battery-integrated semiconductor module according to an embodiment;

FIG. 4B is a top view which shows one step of the method for producing a battery-integrated semiconductor module according to the embodiment;

FIG. 5A is a cross-sectional view which shows one step of a method for producing a battery-integrated semiconductor module according to the embodiment;

FIG. 5B is a top view which shows one step of the method for producing a battery-integrated semiconductor module according to the embodiment;

FIG. 6A is a cross-sectional view which shows one step of a method for producing a battery-integrated semiconductor module according to the embodiment; and

FIG. 6B is a top view which shows one step of the method for producing a battery-integrated semiconductor module according to the embodiment.

### DETAILED DESCRIPTION OF THE INVENTION

Hereinbelow, an embodiment of the present invention will be described in detail with reference to the accompanying drawings. It is to be noted that the drawings are schematic and therefore there is a case where the sizes of elements shown in the drawings or the size ratios among these elements are different from actual ones.

### Embodiment

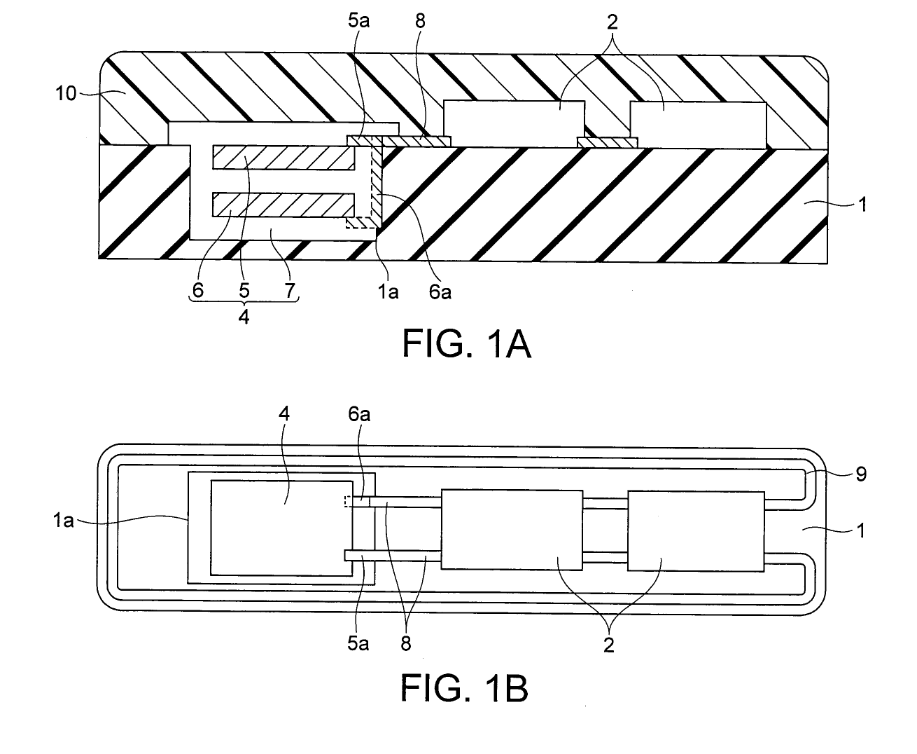

A battery-integrated semiconductor module according to an embodiment of the present invention is shown in FIGS. 1A and 1B. FIG. 1A is a cross-sectional view of the battery-integrated semiconductor module according to the present embodiment, and FIG. 1B is a top view of the battery-integrated semiconductor module shown in FIG. 1A, from which a resin has been removed.

The battery-integrated semiconductor module according to the present embodiment includes a semiconductor device 2 provided on an insulating substrate 1 and a nonaqueous electrolyte battery 4 provided in a recess 1a of the insulating substrate 1. The nonaqueous electrolyte battery 4 has a porous separator 7, a positive electrode 5 and a negative electrode 6 which are provided to face each other via the separator 7, and a nonaqueous electrolyte. The positive electrode 5 and the negative electrode 6 are entirely covered with the separator 7. The nonaqueous electrolyte contains an ionic liquid as a main component, and the positive electrode 5, the negative electrode 6, and the separator 7 are each impregnated with the nonaqueous electrolyte. On the insulating substrate 1, there is provided electric wiring 8 for connecting the semiconductor device 2 and the positive and negative electrodes 5 and 6 of the nonaqueous electrolyte battery 4. In addition, on the insulating substrate 1, there is also provided a loop antenna 9 connected to the semiconductor device 2 for external communication. It is to be noted that the positive and negative electrodes 5 and 6 of the nonaqueous electrolyte battery 4 are connected to the electric wiring 8 via their respective leads 5a and 6a. The semiconductor device 2 and the nonaqueous electrolyte battery 4 are covered with a sealing resin 10.

As described above, according to the present embodiment, the nonaqueous electrolyte of the nonaqueous electrolyte battery 4 contains an ionic liquid as a main component, and the positive and negative electrodes 5 and 6 and the separator 7 are each impregnated with the nonaqueous electrolyte. Therefore, the nonaqueous electrolyte is in contact with the insulating substrate 1 and the sealing resin 10 via the separator 7. That is, the insulating substrate 1 and the sealing resin 10 also serve as a package of the nonaqueous electrolyte battery 4.

As described above, according to the present embodiment, the nonaqueous electrolyte of the nonaqueous electrolyte battery 4 is a liquid electrolyte containing an ionic liquid as a main component. Therefore, the nonaqueous electrolyte battery 4 can achieve higher output characteristics as compared to a case using a solid electrolyte. In addition, as described above, the positive and negative electrodes 5 and 6 and the separator 7 are each impregnated with the nonaqueous electrolyte and therefore the nonaqueous electrolyte is in contact with the insulating substrate 1 and the sealing resin 10 via the separator 7. Such a structure eliminates the necessity to provide a package for the battery, which is conventionally required for a battery containing a liquid electrolyte to produce a battery-integrated semiconductor module using such a battery. That is, according to the present embodiment, it is not necessary to provide an extra package for the nonaqueous electrolyte battery 4 to build the nonaqueous electrolyte battery 4 in the battery-integrated semiconductor module, thereby allowing the downsizing of the nonaqueous electrolyte battery 4.

### (Modifications)

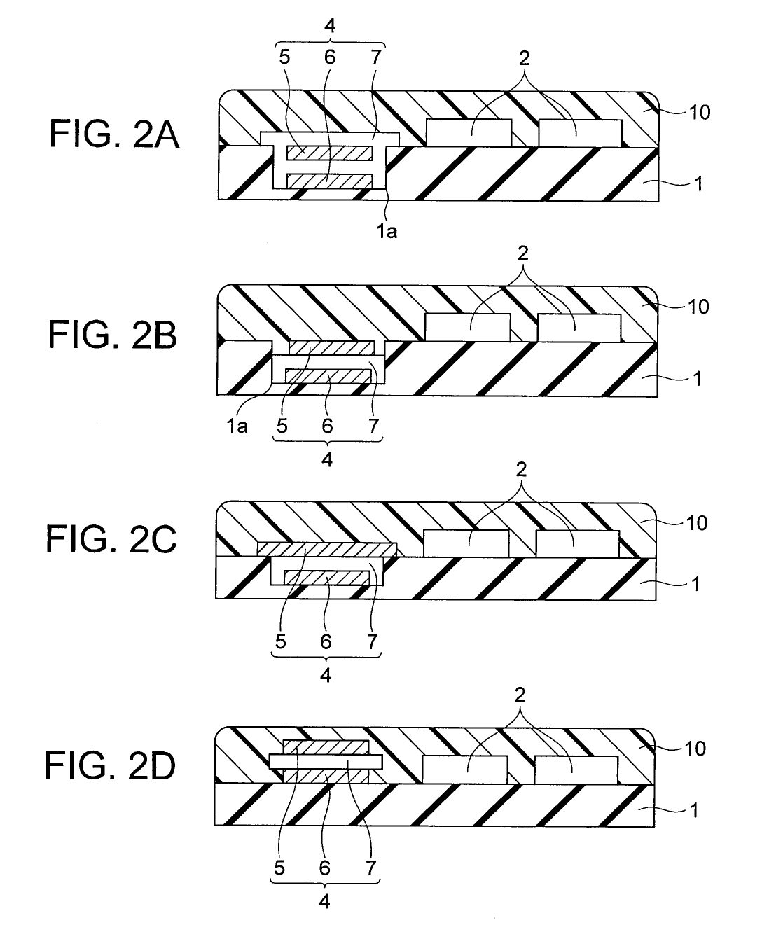

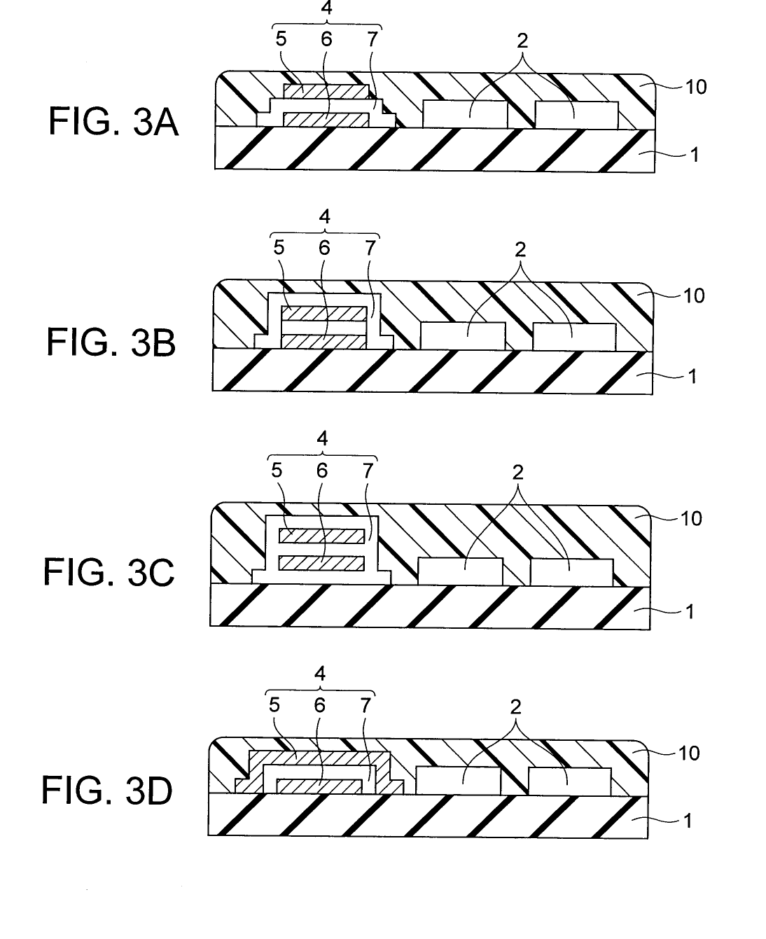

Hereinbelow, modifications of the present embodiment will be described with reference to FIGS. 2A to 3D. It is to be noted that in the following description, explanations of the leads 5a and 6a and the electric wiring 8 are omitted for the sake of brevity.

A battery-integrated semiconductor module according to a first modification shown in FIG. 2A is different from the battery-integrated semiconductor module according to the present embodiment shown in FIG. 1A in that the negative electrode 6 is provided so as to be in contact with the bottom surface of the recess of the insulating substrate 1. As in the case of the first embodiment, according to the first modification, the nonaqueous electrolyte of the nonaqueous electrolyte battery 4 contains an ionic liquid as a main component, and the positive and negative electrodes 5 and 6 and the separator 7 are each impregnated with the nonaqueous electrolyte. Therefore, the nonaqueous electrolyte is in contact with the insulating substrate 1 via the separator 7 or the negative electrode 6 and in contact with the sealing resin 10 via the separator 7. As in the case of the present embodiment, such a structure according to the first modification also makes it possible to obtain a battery-integrated semiconductor module containing a small built-in battery having satisfactory output characteristics.

A battery-integrated semiconductor module according to a second modification shown in FIG. 2B is different from the battery-integrated semiconductor module according to the first modification shown in FIG. 2A in that the surface of the positive electrode 5 on the opposite side of the negative electrode 6 (i.e., the upper surface of the positive electrode 5) and the side surface of the positive electrode 5 are in contact with the sealing resin 10. Therefore, according to the second modification, the nonaqueous electrolyte is in contact with the insulating substrate 1 via the separator 7 or the negative electrode 6 and in contact with the sealing resin 10 via the separator 7 or the positive electrode 5. As in the case of the present embodiment, such a structure according to the second modification also makes it possible to obtain a battery-integrated semiconductor module containing a small built-in battery having satisfactory output characteristics.

A battery-integrated semiconductor module according to a third modification shown in FIG. 2C is different from the battery-integrated semiconductor module according to the second modification shown in FIG. 2B in that the recess 1a of the insulating substrate 1 is covered with the positive electrode 5. Therefore, according to the third modification, the nonaqueous electrolyte is in contact with the insulating substrate 1 via the positive electrode 5, the separator 7, or the negative electrode 6 and in contact with the sealing resin 10 via the positive electrode 5. As in the case of the present embodiment, such a structure according to the third modification also makes it possible to obtain a battery-integrated semiconductor module containing a small built-in battery having satisfactory output characteristics.

A battery-integrated semiconductor module according to a fourth modification shown in FIG. 2D is different from the battery-integrated semiconductor module according to the present embodiment shown in FIG. 1A in that the insulating substrate 1 does not have a recess 1a and that the nonaqueous electrolyte battery 4 is formed by laminating the negative electrode 6, the separator 7, and the positive electrode 5 on the insulating substrate 1 in this order. Therefore, according to the fourth modification, the nonaqueous electrolyte is in contact with the sealing resin 10 via the positive electrode 5, the separator 7, or the negative electrode 6 and in contact with the insulating substrate 1 via the negative electrode 6. As in the case of the present embodiment, such a structure according to the fourth modification also makes it possible to obtain a battery-integrated semiconductor module containing a small built-in battery having satisfactory output characteristics.

A battery-integrated semiconductor module according to a fifth modification shown in FIG. 3A is different from the battery-integrated semiconductor module according to the fourth modification shown in FIG. 2D in that not only the upper surface of the negative electrode 6 but also the side surface of the negative electrode 6 are covered with the separator 7 so that the foot of the separator 7 is in contact with the insulating substrate 1. Therefore, according to the fifth modification, the nonaqueous electrolyte is in contact with the sealing resin 10 via the positive electrode 5 or the separator 7 and in contact with the insulating substrate 1 via the negative electrode 6 or the separator 7. As in the case of the present embodiment, such a structure according to the fifth modification also makes it possible to obtain a battery-integrated semiconductor module containing a small built-in battery having satisfactory output characteristics.

A battery-integrated semiconductor module according to a sixth modification shown in FIG. 3B is different from the battery-integrated semiconductor module according to the fifth modification shown in FIG. 3A in that the side and upper surfaces of the positive electrode 5 are also covered with the separator 7. Therefore, according to the sixth modification, the nonaqueous electrolyte is in contact with the sealing resin 10 via the separator 7 and in contact with the insulating substrate 1 via the negative electrode 6 or the separator 7. As in the case of the present embodiment, such a structure according to the sixth modification also makes it possible to obtain a battery-integrated semiconductor module containing a small built-in battery having satisfactory output characteristics.

A battery-integrated semiconductor module according to a seventh modification shown in FIG. 3C is different from the battery-integrated semiconductor module according to the sixth modification shown in FIG. 3B in that the separator 7 is provided also between the negative electrode 6 and the insulating substrate 1. Therefore, according to the seventh modification, the nonaqueous electrolyte is in contact with the sealing resin 10 via the separator 7 and in contact with the insulating substrate 1 via the separator 7. As in the case of the present embodiment, such a structure according to the seventh modification also makes it possible to obtain a battery-integrated semiconductor module containing a small built-in battery having satisfactory output characteristics.

A battery-integrated semiconductor module according to an eighth modification shown in FIG. 3D is different from the battery-integrated semiconductor module according to the present embodiment shown in FIG. 1A in that the insulating substrate 1 does not have a recess 1a and that the negative electrode 6 is provided on the insulating substrate 1, the separator 7 is formed so that the negative electrode 6 is covered with it, and the positive electrode 5 is formed so that the separator 7 is covered with it. As in the case of the first embodiment, according to the eighth modification, the nonaqueous electrolyte of the nonaqueous electrolyte battery 4 contains an ionic liquid as a main component, and the positive and negative electrodes 5 and 6 and the separator 7 are each impregnated with the nonaqueous electrolyte. Therefore, according to the eighth modification, the nonaqueous electrolyte is in contact with the sealing resin 10 via the positive electrode 5 and in contact with the insulating substrate 1 via the positive electrode 5, the negative electrode 6, or the separator 7. As in the case of the present embodiment, such a structure according to the eighth modification also makes it possible to obtain a battery-integrated semiconductor module containing a small built-in battery having satisfactory output characteristics.

It is to be noted that in the above embodiment and modifications of the embodiment, the positive electrode 5 is provided on the upper side of the negative electrode 6, but the positive electrode 5 and the negative electrode 6 may change places.

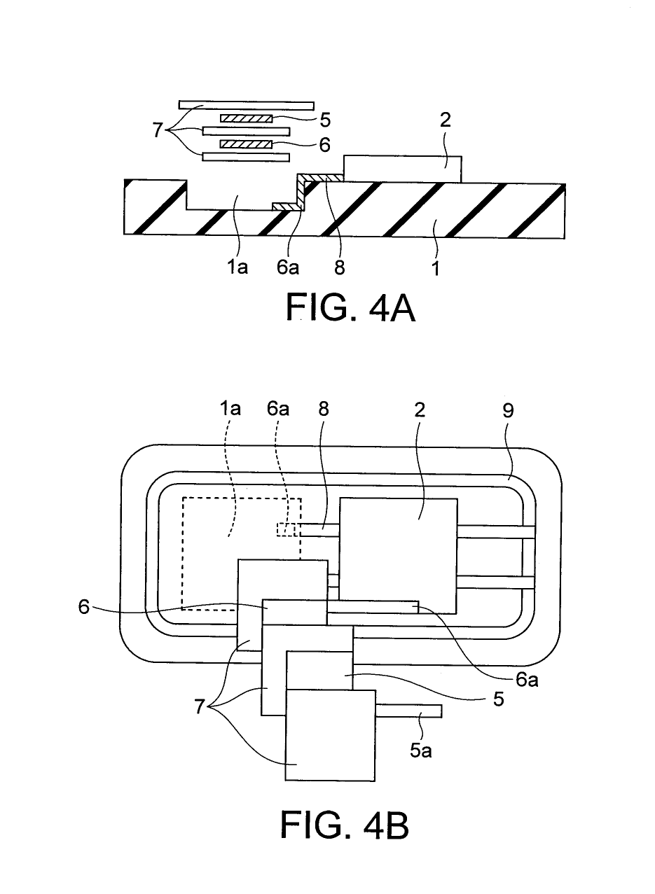

Hereinbelow, a method for producing a battery-integrated semiconductor module according to the present embodiment will be described with reference to FIGS. 4A to 6B.

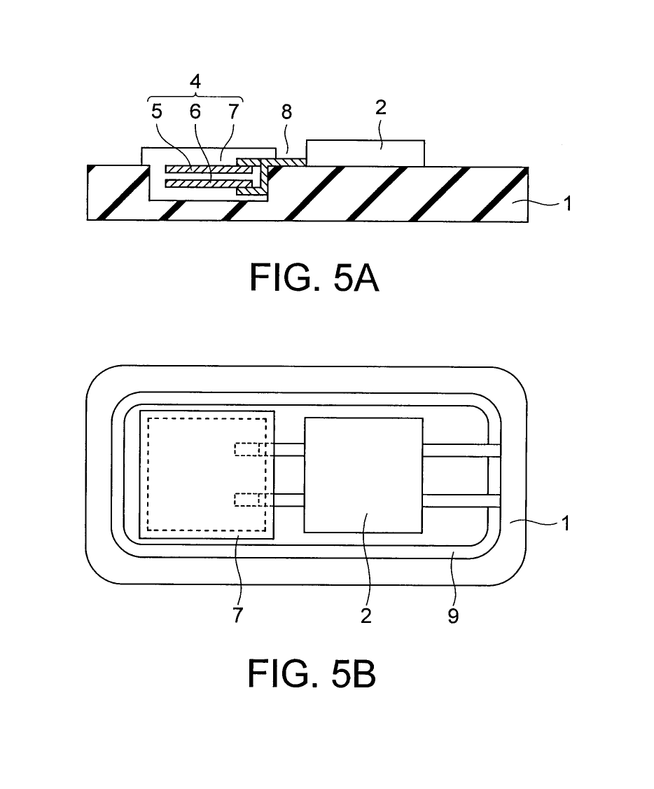

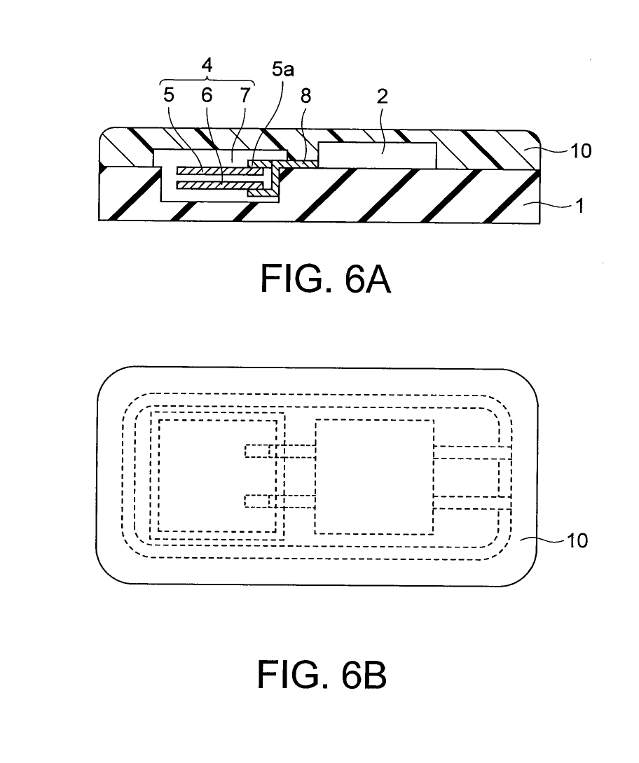

First, a semiconductor device 2, electric wiring 8, and a loop antenna 9 are formed on an insulating substrate 1 provided with a recess 1a for accommodating a battery (see FIGS. 4A and 4B). Then, a separator 7, a negative electrode 6, a separator 7, a positive electrode 5, and a separator 7 are laminated within the recess 1a in this order, and the positive and negative electrodes 5 and 6 are connected through their respective lead wires 5a and 6a to the electric wiring 8 of the semiconductor device 2 (see FIGS. 5A and 5B). After the entire of the thus obtained structure is vacuum-dried at 100° C., a nonaqueous electrolyte composed of an ionic liquid containing a lithium salt dissolved therein is poured into the recess 1a, in which the laminate comprising the separator 7, the negative electrode 6, the separator 7, the positive electrode 5, and the separator 7 is accommodated, and then the pressure of the ambient atmosphere is changed from vacuum to atmospheric pressure to impregnate the positive electrode 5, the negative electrode 6, and the separator 7 with the nonaqueous electrolyte (see FIGS. 5A and 5B). Then, the insulating substrate 1 is placed in a mold and kept at 60° C., and a liquid epoxy resin composition 10 containing an epoxy compound, a curing agent, a curing accelerator, and a filler is charged into the mold under vacuum so that the insulating substrate 1 is covered with the liquid epoxy resin composition 10. Then, the mold is heated at 110° C. for 1 hour, and is further heated at 150° C. for 4 hours to cure the epoxy resin composition 10. In this way, a battery-integrated semiconductor module is produced (see FIGS. 6A and 6B).

### (Nonaqueous Electrolyte Battery)

Hereinbelow, the nonaqueous electrolyte battery 4 according to the present embodiment will be described in detail. As described above, the nonaqueous electrolyte battery 4 includes the positive electrode 5, the negative electrode 6, and the separator 7, and the positive electrode 5, the negative electrode 6, and the separator 7 are each impregnated with a nonaqueous electrolyte containing an ionic liquid as a main component. Each of the positive and negative electrodes 5 and 6 can be obtained by, for example, laminating two or more short strip-shaped electrodes, or by winding a long strip-shaped electrode or folding it in a zigzag manner. The number of short strip-shaped electrodes to be laminated or the length of a long strip-shaped electrode to be wound into a coil can be increased or decreased depending on a desired function of the battery-integrated semiconductor module.

Hereinbelow, the nonaqueous electrolyte, the positive electrode, the negative electrode, and the separator will be described.

### 1) Nonaqueous Electrolyte

As the nonaqueous electrolyte, one containing, as a main component, an ionic liquid containing a lithium salt dissolved therein can be used. The ionic liquid is a salt which is liquid at room temperature, nonvolatile, and nonflammable and is composed of a cation and an anion.

As a conventional nonaqueous electrolyte, there is known a nonaqueous electrolyte obtained by dissolving a lithium salt in an organic solvent typified by EC (ethylene carbonate) or PC (propylene carbonate). However, in a case where such a conventional nonaqueous electrolyte is used for the battery-integrated semiconductor module according to the present embodiment, the organic solvent vaporizes in the step of vacuum impregnation with the poured nonaqueous electrolyte or the step of curing the liquid epoxy resin composition so that the battery-integrated semiconductor module loses its battery characteristics. In addition, there is a possibility that the cured epoxy resin is swelled by the organic solvent and is then cracked so that a short is caused in a circuit containing the semiconductor device 2 and therefore the semiconductor device loses its function.

However, as described above, since the nonaqueous electrolyte according to the present embodiment contains a nonvolatile ionic liquid as a main component, it does not vaporize in the step of vacuum impregnation with the poured nonaqueous electrolyte or the step of curing the liquid epoxy resin composition. In addition, the cationic component (which will be described later) constituting the ionic liquid functions as a curing accelerator for the liquid epoxy resin. That is, the ionic liquid does not cause the swelling of the epoxy resin. On the contrary, the ionic liquid has a positive effect of accelerating curing and enhancing the strength of the cured epoxy resin.

As described above, the ionic liquid is a salt composed of a cation and an anion. The cation preferably has a structure represented by the following structural formula (1) or (2):

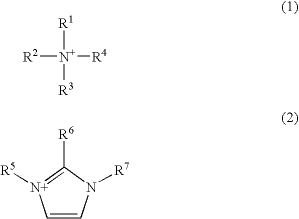

These cations represented by the above structural formulas (1) and (2) can be used singly or in combination of two or more of them. In the structural formula (1), R¹, R², R³, and R⁴ each represent a substituent group selected from among alkyl groups having 4 carbon atoms or less, ether groups having 4 carbon atoms or less, ester groups having 4 carbon atoms or less, and carbonate groups having 4 carbon atoms or less, wherein R¹ and R² may be bonded together to form a cyclic structure having 4 to 5 carbon atoms. In the structural formula (2), R⁵ and R⁷ each represent a substituent group selected from among alkyl groups having 4 carbon atoms or less, ether groups having 4 carbon atoms or less, ester groups having 4 carbon atoms or less, and carbonate groups having 4 carbon atoms or less, and R⁶ is a substituent group selected from among hydrogen and a methyl group.

Examples of the alkyl groups having 4 carbon atoms or less include a methyl group, an ethyl group, a propyl group, an isopropyl group, a butyl group, an isobutyl group, a tert-butyl group, and a sec-butyl group.

Examples of the ether groups having 4 carbon atoms or less include a methoxymethyl group, a methoxyethyl group, a methoxypropyl group, a (2-methoxy)propyl group, an ethoxymethyl group, and an ethoxyethyl group. Examples of the ester groups having 4 carbon atoms or less include a methoxycarbonylmethyl group, a methoxycarbonylethyl group, an ethoxycarbonylmethyl group, an acetylmethyl group, an acetylethyl group, and a propionylmethyl group.

Examples of the carbonate groups having 4 carbon atoms or less include those having a chain structure such as —CH₂OCOOCH₃, —CH₂CH₂OCOOCH₃, and —CH₂OCOOCH₂CH₃, and those having a cyclic structure such as

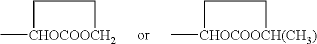

Specific examples of the cation include N,N,N-trimethylbutyl ammonium ion, N-ethyl-N,N-dimethylpropyl ammonium ion, N-ethyl-N,N-dimethylbutyl ammonium ion, N,N-dimethyl-N-propylbutyl ammonium ion, N-(2-methoxyethyl)-N,N-dimethylethyl ammonium ion, N-methyl-N-propylpyrrolidinium ion, N-butyl-N-methylpyrrolidinium ion, N-sec-butyl-N-methylpyrrolidinium ion, N-(2-methoxyethyl)-N-methylpyrrolidinium ion, N-(2-ethoxyethyl)-N-methylpyrrolidinium ion, N-methyl-N-propylpiperidinium ion, N-butyl-N-methylpiperidinium ion, N-sec-butyl-N-methylpiperidinium ion, N-(2-methoxyethyl)-N-methylpiperidinium ion, N-(2-ethoxyethyl)-N-methylpiperidinium ion, 1-ethyl-3-methylimidazolium ion, 1-methyl-3-propylimidazolium ion, 1-butyl-3-methylimidazolium ion, 1-ethyl-2,3-dimethylimidazolium ion, 1-ethyl-3,4-dimethylimidazolium ion, 1-ethyl-2,3,4-trimethylimidazolium ion, 1-ethyl-2,3,5-trimethylimidazolium ion, and 1,2-dimethyl-3-propylimidazolium ion.

Among these cations, N,N,N-trimethylbutyl ammonium ion, N-ethyl-N,N-diemethylpropyl ammonium ion, N-ethyl-N,N-dimethylbutyl ammonium ion, N-(2-methoxyethyl)-N,N-dimethylethyl ammonium ion, N-methyl-N-propylpyrrolidinium ion, N-butyl-N-methylpyrrolidinium ion, N-methyl-N-propylpiperidinium ion, N-butyl-N-methylpiperidinium ion, 1-ethyl-3-methylimidazolium ion, 1-ethyl-2,3-dimethylimidazolium ion, and 1,2-dimethyl-3-propylimidazolium ion are preferred because an ionic liquid having a low viscosity and excellent voltage resistance can be obtained. More preferred are 1-ethyl-3-methylimidazolium ion, 1-ethyl-2,3-dimethylimidazolium ion, and 1,2-dimethyl-3-propylimidazolium ion because the solubility of a lithium salt in the ionic liquid can be increased and therefore an electrolyte having a high ion conductivity can be obtained.

The anion is preferably selected from among PF₆⁻, [PF₃(C₂F₅)₃]⁻, [PF₃(CF₃)₃]⁻, BF₄⁻, [BF₂(CF₃)₂]⁻, [BF₂(C₂(C₂F₅)₂]⁻, [BF₃(CF₃)]⁻, [BF₃(C₂F₅)]⁻, [B(COOCOO)₂]⁻, CF₃SO₃⁻, C₄F₉SO₃⁻, [(CF₃SO₂)₂N]⁻ (TFSI⁻), [(C₂F₅SO₂)₂N]⁻ (BETI⁻), [(CF₃SO₂)(C₄F₉SO₂)N]⁻, [(CN)₂N]⁻, [(CF₃SO₂)₃C]⁻, and [(CN)₃C]⁻. These anions can be used singly or in combination of two or more of them. Among them, BF₄⁻, [BF₃(CF₃)]⁻, [BF₃(C₂F₅)]⁻, TFSI⁻, BETI⁻, and [(CF₃SO₂)(C₄F₉SO₂)N]⁻ are preferred because an ionic liquid having a low viscosity can be obtained. More preferred are TFSI⁻, BETI⁻, and [(CF₃SO₂)(C₄F₉SO₂)N]⁻ because an ionic liquid having excellent resistance to high temperature can be obtained.

The ionic liquids composed of one or more of the above-mentioned cations and one or more of the above-mentioned anions can be used singly or in combination of two or more of them.

Examples of a lithium salt to be added to the ionic liquid include LiPF₆, Li[PF₃(C₂F₅)₃], Li[PF₃(CF₃)₃], LiBF₄, Li[BF₂(CF₃)₂], Li[BF₂(C₂F₅)₂], Li[BF₃(CF₃)], Li[BF₃(C₂F₅)], LiBOB, LiTf, LiNf, LiTFSI, LiBETI, Li[(CF₃SO₂)(C₄F₉SO₂)N], Li[(CN)₂N], and Li[(CF₃SO₂)₃C]. An anion of such a lithium salt to be added to the ionic liquid may be the same as or different from the anion constituting the ionic liquid. These lithium salts can be used singly or in combination of two or more of them.

Among these lithium salts, LiBF₄, Li[BF₃(CF₃)], Li[BF₃(C₂F₅)], LiTFSI, LiBETI, and Li[(CF₃SO₂)(C₄F₉SO₂)N] are preferred because a nonaqueous electrolyte having a low viscosity can be obtained. More preferred are LiTFSI, LiBETI, and Li[(CF₃SO₂)(C₄F₉SO₂)N] because a nonaqueous electrolyte having excellent resistance to high temperature can be obtained. The concentration of the lithium salt is preferably 0.2 M or more but 4.0 M or less. If the concentration of the lithium salt is less than 0.2 M, the lithium ion conductivity of the nonaqueous electrolyte is lowered so that the large-current discharge characteristic of the nonaqueous electrolyte battery is deteriorated. On the other hand, if the concentration of the lithium salt exceeds 4.0 M, the viscosity of the nonaqueous electrolyte is increased, which makes it difficult to impregnate the electrodes and the separator with the nonaqueous electrolyte. In addition, the lithium salt is not completely dissolved and is then precipitated out of the ionic liquid, and therefore the nonaqueous electrolyte battery cannot have satisfactory characteristics. The concentration of the lithium salt is particularly preferably 0.5 M or more but 2.5 M or less.

### 2) Positive Electrode

The positive electrode can be produced by, for example, kneading a positive electrode active material, a conductive agent, and a binder and then forming the thus obtained mixture into a film. The positive electrode may use a sheet-shaped current collector to improve electric conductivity.

Examples of the positive electrode active material include: lithium metal oxides such as lithium cobalt oxides (LiₓCoO₂), lithium iron oxides (LiₓFeO₂), lithium nickel oxides (LiₓNiO₂), lithium nickel cobalt oxides (LiₓNi_{y}Co_{1-y}O; 0<y<1), and lithium manganese oxides (LiₓMn₂O₄); and metal oxides such as manganese oxide (MnO₂), vanadium pentoxide (V₂O₅), chromium oxides (Cr₃O₈, CrO₂), molybdenum trioxide (MoO₃), and titanium dioxide (TiO₂). The use of such a metal oxide makes it possible to obtain a high-voltage and high-capacity nonaqueous electrolyte secondary battery. Among these positive electrode active materials, LiₓCoO₂, LiₓFeO₂, LiₓNiO₂, LiₓNi_{y}Co_{1-y}O₂ (0<y<1), and LiMn₂O₄ are preferred because a high-voltage and high-energy density nonaqueous electrolyte battery can be obtained. It is to be noted that x in the chemical formulas of the compounds mentioned above satisfies 0≦x≦2, preferably 0<x<1.1 from the viewpoint of improving the reversibility of discharge and charge reaction.

Examples of the conductive agent include, but are not limited to, acetylene black, carbon black, and graphite. Examples of the binder include, but are not limited to, polytetrafluoroethylene (PTFE), polyvinylidene fluoride (PVdF), ethylene-propylene-diene copolymer (EPDM), and styrene-butadiene rubber (SBR).

Examples of the positive electrode current collector include metal foils and metal meshes made of aluminum, stainless steel, nickel, tungsten, titanium, or molybdenum. Among these metals, aluminum is preferred because a lightweight and high-energy density nonaqueous electrolyte battery can be obtained. The surface of the current collector may be coated with a metal or an alloy having oxidation resistance to suppress oxidation.

Examples of the binder include polytetrafluoroethylene (PTFE), polyvinylidene fluoride (PVdF), ethylene-propylene-butadiene rubber (EPBR), and styrene-butadiene rubber (SBR). Among these binders, PVdF is preferred because it has high binding ability and therefore a nonaqueous electrolyte battery having excellent cycle characteristics can be obtained.

### 3) Negative Electrode

The negative electrode can be produced by, for example, kneading a negative electrode active material, a binder, and if necessary, a conductive agent and then by forming the thus obtained mixture into a film. The negative electrode may use a sheet-shaped current collector to improve electric conductivity.

Examples of the negative electrode active material include those used for conventional lithium ion batteries and lithium batteries. Among them, at least one selected from the group consisting of metal oxides, metal sulfides, metal nitrides, lithium metal, lithium alloys, lithium composite oxides, and carbonaceous materials occluding and releasing lithium ions is preferably used as the negative electrode active material.

Examples of the metal oxides include tin oxides, silicon oxides, titanium-containing metal composite oxides, niobium oxides, and tungsten oxides. Examples of the metal sulfides include tin sulfides and titanium sulfides. Examples of the metal nitrides include lithium cobalt nitrides, lithium iron nitrides, and lithium manganese nitrides. Examples of the lithium alloys include lithium aluminum alloys, lithium tin alloys, lithium lead alloys, and lithium silicon alloys. Examples of the carbonaceous materials include graphite, isotropic graphite, coke, carbon fibers, spherical carbon, resin-fired carbon, and pyrolytic vapor-grown carbon. Among these carbonaceous materials, carbon fibers and spherical carbon made of mesophase pitch are preferred because a negative electrode having high charging efficiency and improved cycle life can be obtained. In the carbon fibers or spherical carbon made of mesophase pitch, graphite crystals are preferably oriented radially.

Among the above-mentioned negative electrode active materials, titanium-containing metal composite oxides are preferred because a nonaqueous electrolyte battery having excellent charge-discharge cycle characteristics can be obtained.

Examples of the titanium-containing metal composite oxides include lithium titanium oxides and titanium-based oxides not containing lithium at the time of synthesis of the oxides. Examples of the lithium titanium oxides include Li₄₊ₓTi₅O₁₂ (0≦x≦3) and Li₂₊ₓTi₃O₇ (0≦x≦3). Examples of the titanium-based oxides include TiO₂ and metal composite oxides containing Ti and at least one element selected from the group consisting of P, V, Sn, Cu, Ni, and Fe.

Among these titanium-containing metal composite oxides, Li₄₊ₓTi₅O₁₂ (0≦x≦3) is more preferred because a nonaqueous electrolyte battery whose discharge voltage curve is flat can be obtained.

Examples of the negative electrode current collector include metal foils and metal meshes made of copper, aluminum, nickel, stainless steel, tungsten, or titanium. Among these metals, aluminum is preferred because a lightweight and high-energy density nonaqueous electrolyte battery can be obtained. The surface of the current collector may be coated with a metal or an alloy having oxidation resistance to suppress oxidation.

Examples of the binder include polytetrafluoroethylene (PTFE), polyvinylidene fluoride (PVdF), ethylene-propylene-butadiene rubber (EPBR), styrene-butadiene rubber (SBR), and carboxymethylcellulose (CMC). Among these binders, PVdF is preferred because it has high binding ability and therefore a nonaqueous electrolyte battery having excellent cycle characteristics can be obtained.

### 4) Separator

Examples of the separator include porous films containing an organic polymer such as polytetrafluoroethylene (PTFE), polytetrafluoroethylene-perfluoroalkoxyethylene (PFA), polyhexafluoropropylene (HFP), polytetrafluoroethylene-hexafluoropropylene (FEP), polyethylene-tetrafluoroethylene (ETFE), polyethyleneterephthalate (PET), polyamide, polyimide, cellulosepolyethylene, polypropylene, or polyvinylidene fluoride (PVdF), synthetic resin non-woven fabrics, and glass fiber non-woven fabrics. The separator may contain inorganic oxide particles made of alumina, zirconium oxide, or the like.

### 5) Sealing Resin

Hereinbelow, the sealing resin will be described.

The sealing resin is not particularly limited as long as it is generally used for sealing a semiconductor device, but an epoxy resin is preferably used. More preferably, an epoxy resin having two or more epoxy groups in one molecule is used.

Specific examples of the epoxy resin include bisphenol F type epoxy resins, bisphenol A type epoxy resins, phenol novolac epoxy resins, cresol novolac epoxy resins, naphthol-based novolac epoxy resins, bisphenol A novolac epoxy resins, naphthalenediol epoxy resins, alicyclic epoxy resins, epoxy compounds derived from tri- or tetra-(hydroxyphenyl)alkanes, bishydroxybiphenyl-based epoxy resins, dihydroxydiphenylmethane-based epoxy resins, epoxidized phenolaralkyl resins, heterocyclic epoxy resins, and aromatic diglycidylamine compounds.

These epoxy resins may be used in combination of two or more of them. It is to be noted that these epoxy resins are preferably in a liquid state at room temperature. Among the above-mentioned epoxy resins, in a case where a bisphenol F type epoxy resin is used to obtain a resin composition, the resin composition has a low viscosity and excellent storage stability. For this reason, in a case where two or more of these epoxy resins are mixed to obtain an epoxy resin matrix, a bisphenol F type epoxy resin is preferably used as at least one component of the epoxy resin matrix.

The epoxy resin is obtained by curing an epoxy resin composition containing an epoxy compound, a curing agent (polymerization initiator), a filler, and, if necessary, a curing accelerator and a catalyst.

Examples of the curing agent include acid anhydrides, amines, mercaptans, phenols, and dicyanamides. Among these curing agents, acid anhydrides are preferred because even when they are mixed into the nonaqueous electrolyte, the performance of the nonaqueous electrolyte battery is not deteriorated. Specific examples of the acid anhydrides include phthalic anhydride, tetrahydrophthalic anhydride, methyltetrahydrophthalic anhydride, himic anhydride (3,6-endomethylenetetrahydrophthalic anhydride), methyl-3,6-endomethylenephthalic anhydride, hexahydrophthalic anhydride, methylhexahydrophthalic anhydride, trimellitic anhydride, pyromellitic anhydride, maleic anhydride, succinic anhydride, dodecenylsuccinic anhydride, benzophenone tetracarboxylic anhydride, ethyleneglycolbistrimellitate dianhydride, glycerol tristrimellitate trianhydride, 1,10-decamethylene bistrimellitate dianhydride, and methylcyclohexene dicarboxylic anhydride.

These acid anhydrides may be used in combination of two or more of them. It is to be noted that these acid anhydrides are preferably in a liquid state at room temperature. The amount of the curing agent contained in the epoxy resin composition is not particularly limited, but the equivalent ratio between the epoxy resin and the curing agent (reactive group of curing agent/epoxy group) is preferably in the range of 0.5 to 1.5, more preferably in the range of 0.8 to 1.2. If the equivalent ratio is less than 0.5, curing reaction does not sufficiently proceed. On the other hand, if the equivalent ratio exceeds 1.5, there is a fear that the properties, especially humidity resistance, of a cured product of the epoxy resin composition are deteriorated.

The curing accelerator is not particularly limited, and any compound can be used as the curing accelerator as long as it is a latent catalyst which shows catalytic activity at a temperature of 60° C. or higher. If the curing accelerator shows its catalytic activity at a temperature of less than 60° C., the storage stability of the resin composition is significantly deteriorated, which makes it impossible to stably store the resin composition for a long time. In addition to that, the viscosity of the running resin composition is increased in the step of sealing a semiconductor device, which impairs the moldability of the resin composition.

Specific examples of such a latent curing accelerator include: decomposition type catalysts which have a high melting point and are activated by dissolution in an epoxy resin at a high temperature, such as dicyandiamide, high-melting point imidazole compounds, organic acid dihydrazides, aminomaleonitrile, melamine and derivatives thereof, and polyamines; basic catalysts activated by decomposition at a high temperature, such as amineimide compounds and tertiary amine salts and imidazole salts dissolvable in an epoxy resin; cationic polymerization catalysts activated by dissociation at a high temperature, such as Lewis acid salts typified by boron trifluoride monoethylamine salt, Lewis acid complexes, Bronsted acid salts typified by aliphatic sulfonium salts of Bronsted acids; and adsorption type catalysts obtained by allowing porous compounds such as molecular sieve and zeolite to adsorb catalysts. Among these curing accelerators, an imidazolium compound having substituent groups at 1- and 3-positions is preferred because even when it is mixed into the nonaqueous electrolyte, the performance of the nonaqueous electrolyte battery is not deteriorated. Specific examples of such an imidazolium compound include 1-dodecyl-2-methyl-3-benzylimidazolium cation and 1,3-dibenzyl-2-methylimidazolium cation.

The amount of the curing accelerator contained in the resin composition is not particularly limited, but is preferably in the range of 0.01 wt % to 10 wt % with respect to the amount of the resin matrix involved in reaction. If the amount of the curing accelerator is less than 0.01 wt %, the curing characteristics of the resin composition tend to be deteriorated. On the other hand, if the amount of the curing accelerator exceeds 10 wt %, there is a fear that the humidity resistance of a cured product of the resin composition and the storage stability of the resin composition are deteriorated.

Examples of the filler include inorganic fillers. A preferred example of the inorganic filler includes spherical fused silica powder whose maximum particle diameter is 40 μm or less. If the maximum particle diameter exceeds 40 μm, the ability of the resin composition to fill the gap between the semiconductor device and the substrate is deteriorated, thus lowering the moldability of a semiconductor apparatus. The fused silica powder is most preferably a mixture obtained by appropriately mixing fused silica powder having an average particle diameter of 1 μm to 10 μm and fused silica powder having an average particle diameter of less than 1 μm. The filler obtained by mixing fused silica powder having a large average particle diameter and fused silica powder having a small average particle diameter can easily have a close-packing structure, thereby making it possible to obtain a resin composition which has good ability to fill the gap between the semiconductor device and the substrate even when it contains a large amount of fused silica powder.

The fused silica powder may be used together with another inorganic filler. Specific examples of another inorganic filler include crystalline silica powder, talc, alumina powder, silicon nitride powder, aluminum nitride powder, calcium silicate powder, calcium carbonate powder, barium sulfate powder, and magnesia powder.

However, the amount of the inorganic filler contained in the resin composition needs to be determined so that the resin composition will not significantly lose its mobility, storage stability, and flowability into the gap between the semiconductor device and the substrate. In addition, the inorganic filler preferably undergoes surface treatment to further improve humidity resistance. The surface treatment can be carried out using a silane coupling agent, and the silane coupling agent is not particularly limited as long as it is usually used for surface treatment.

Specific examples of the silane coupling agent include epoxysilane, aminosilane, mercaptosilane, and acrylsilane. The amount of the silane coupling agent to be added to the filler is preferably in the range of 0.02 to 10 parts by weight per 100 parts by weight of the entire filler. If the amount of the silane coupling agent is less than 0.02 part by weight, there is a fear that the strength of a molded product obtained by curing the resin composition is lowered. On the other hand, if the amount of the silane coupling agent exceeds 10 parts by weight, there is a fear that the hygroscopicity of the molded product is likely to become high and voids are likely to be produced. As the filler other than the inorganic filler, an organic filler may be used. By using an organic filler, it is possible for the liquid epoxy resin composition to have a low viscosity and therefore to have excellent mobility and moldability. In addition, it is also possible to obtain a cured product of the epoxy resin composition having low stress.

### EXAMPLES

Hereinbelow, an example of the present invention will be described in detail with reference to the accompanying drawings.

### Example 1

A battery-integrated semiconductor module shown in FIGS. 1A and 1B was produced in the following manner.

Lithium cobalt oxide (LiCoO₂) was prepared as a positive electrode active material. Then, a positive electrode mixture was prepared by adding, to the positive electrode active material, graphite powder as a conductive agent in an amount of 8 wt % of the total amount of the positive electrode mixture and an N-methylpyrrolidone (NMP) solution of polyvinylidene fluoride (PVdF) as a binder in an amount of 5 wt % of the total amount of the positive electrode mixture. The thus obtained coating liquid was applied onto aluminum foil, and was then dried to form a positive electrode sheet.

On the other hand, lithium titanate was prepared as a negative electrode active material. Then, a negative electrode mixture was prepared by adding, to the negative electrode active material, acetylene black powder as a conductive agent in an amount of 8 wt % of the total amount of the negative electrode mixture and an NMP solution of PVdF as a binder in an amount of 5 wt % of the total amount of the negative electrode mixture. The thus obtained coating liquid was applied onto aluminum foil, and was then dried to form a negative electrode sheet.

A piece measuring 5 mm×5 mm was cut out of each of the positive electrode sheet and the negative electrode sheet to prepare a positive electrode 5 and a negative electrode 6. Then, an aluminum foil strip having a width of 1 mm was ultrasonically welded to each of the positive and negative electrodes 5 and 6 to form a lead 5a and a lead 6a. Pieces of a porous PET film each measuring 7 mm×7 mm were prepared as a separator 7. Electric wiring 8 was formed on an insulating substrate 1, and a semiconductor device 2 was mounted on the insulating substrate 1, and a recess 1a having an opening of 6 mm×6 mm and a depth of 100 μm was formed in the insulating substrate 1. In the recess 1a, the separator 7, the positive electrode 5, the separator 7, the negative electrode 6, and the separator 7 were laminated in this order, and the outermost peripheral portion of the separator 7 was thermally welded to the insulating substrate 1 to fix the positive electrode 5, the negative electrode 6, and the separator 7 to the insulating substrate 1. Then, the lead 5a of the positive electrode 5 and the lead 6a of the negative electrode 6 were connected to the electric wiring 8 provided on the insulating substrate 1.

LiBETI was dissolved in 1-propyl-2,3-dimethylimidazolium BETI at a concentration of 0.75 mol/L to prepare a nonaqueous electrolyte containing an ionic liquid as a main component. The nonaqueous electrolyte was dropped onto the laminate, comprising the positive electrode 5, the negative electrode 6, and the separator 7, provided in the recess 1a of the insulating substrate 1, and then the positive electrode 5, the negative electrode 6, and the separator 7 were impregnated with the nonaqueous electrolyte by vacuum impregnation to form a nonaqueous electrolyte battery 4.

An epoxy resin, a curing agent, a curing accelerator, and a filler were mixed to prepare an epoxy resin composition as a sealing resin in the following manner. 100 parts by weight of a bisphenol F type epoxy resin (epoxy equivalent: 169, Epicoat 807 manufactured by Yuka Shell Epoxy K.K.) as an epoxy resin, 100 parts by weight of methyltetrahydrophthalic anhydride as an acid anhydride-based curing agent, 5 parts by weight of 1,3-dibenzyl-2-methylimidazolium chloride as an imidazolium compound-based curing accelerator, and 180 parts by weight of spherical silica SP-3B (average particle diameter: 3.3 μm, maximum particle diameter: 12 μm, Fuso Siltech K.K.) and 80 parts by weight of spherical silica SO-E5 (average particle diameter: 1.5 μm, maximum particle diameter: 3.0 μm, Admatechs Co., Ltd.) as spherical inorganic fillers were mixed to prepare a liquid epoxy resin composition 10.

The insulating substrate 1 having the semiconductor device 2 and the nonaqueous electrolyte battery 4 mounted thereon was heated to 60° C., and then the epoxy resin composition 10 was fed onto the insulating substrate 1. Then, vacuum impregnation was carried out. The insulating substrate 1 was further heated at 110° C. for 8 hours to cure the epoxy resin composition 10. In this way, a battery-integrated semiconductor module was produced.

### Comparative Example 1

A battery-integrated semiconductor module was produced in the same manner as in Example 1 except that the nonaqueous electrolyte was replaced with one not containing an ionic liquid as a main component. The nonaqueous electrolyte used in Comparative Example 1 was prepared by dissolving LiPF₆ in a solvent, obtained by mixing ethylmethylcarbonate and ethylene carbonate in a volume ratio of 1:1, at a concentration of 1.0 mol/L. However, the battery of the battery-integrated semiconductor module of Comparative Example 1 did not perform its function. Then, the semiconductor module was cut to observe the battery. As a result, it was found that the nonaqueous electrolyte was in a solid state and the solid nonaqueous electrolyte mainly contained ethylene carbonate and LiPF₆. From the result, it can be considered that low-boiling ethylmethylcarbonate contained in the nonaqueous electrolyte was volatilized in the step of vacuum impregnation with the nonaqueous electrolyte and the step of curing the epoxy resin composition during production of the battery-integrated semiconductor module of Comparative Example 1.

### Comparative Example 2

A nonaqueous electrolyte battery having a laminated film package was formed in the following manner. First, a piece measuring 5 mm×5 mm was cut out of each of the positive and negative electrode sheets formed in Example 1, and an aluminum foil strip having a width of 1 mm was ultrasonically welded as a lead to each of the positive and negative electrodes. Then, a piece of porous PET film measuring 7 mm×7 mm was prepared as a separator, and pieces of aluminum laminate film each measuring 7 mm×7 mm were prepared as a package material of a battery. The aluminum laminate film, the positive electrode, the separator, the negative electrode, and the aluminum laminate film were laminated in this order to prepare a laminated structure, and then the nonaqueous electrolyte containing, as a main component, an ionic liquid that is the same as that used in Example 1 was poured onto the laminated structure. An attempt was made to seal the nonaqueous electrolyte battery by thermally welding the outermost peripheral portions of the pieces of aluminum laminate film together, but the attempt was unsuccessful. The reason for this can be considered that the 1 mm-wide outer peripheral portion of the aluminum laminate film was too small for thermal welding. It has become apparent that the outermost peripheral portion of the aluminum laminate film to be thermally welded needs to have a width of 3 mm to allow the nonaqueous electrolyte battery to have adequate strength. That is, in a case where the positive and negative electrodes each have a size of 5 m×5 mm, the pieces of aluminum laminate film need to have a size of 11 mm×11 mm to pack the electrodes therein. However, in this case, it was impossible to mount the nonaqueous electrolyte battery on a semiconductor module having the same size as the semiconductor module of Example 1.

On the other hand, in a case where pieces of aluminum laminate film each measuring 7 mm×7 mm are used as a package material, the positive and negative electrodes need to have a size of 1 mm×1 mm to ensure sealing of the nonaqueous electrolyte battery. However, in this case, it was impossible to obtain electric power large enough to drive the semiconductor module.

As has been described above, according to the present invention, it is possible to provide a battery-integrated semiconductor module containing a small built-in battery having satisfactory output characteristics.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concepts as defined by the appended claims and their equivalents.

What is claimed is:

1. A battery-integrated semiconductor module comprising:
an insulating substrate;
a semiconductor device provided on the insulating substrate;
a nonaqueous electrolyte battery for driving the semiconductor device, which is provided in and/or on the insulating substrate and comprises a positive electrode, a negative electrode, a separator for separating the positive electrode and the negative electrode from each other, and a nonaqueous electrolyte containing an ionic liquid as a main component, with which the positive electrode, the negative electrode, and the separator are impregnated; and
a sealing resin provided to cover the semiconductor device and the nonaqueous electrolyte battery, wherein any one of the positive electrode, the negative electrode, and the separator is in contact with the insulating substrate and the sealing resin.

2. The semiconductor module according to claim 1, wherein the ionic liquid contains a cation represented by the following formula (1) or (2): 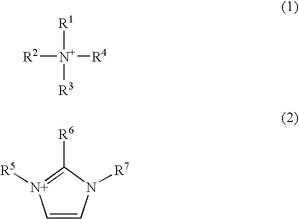
wherein R¹, R², R³, and R⁴ each represent a substituent group selected from among alkyl groups having 4 carbon atoms or less, ether groups having 4 carbon atoms or less, ester groups having 4 carbon atoms or less, and carbonate groups having 4 carbon atoms or less, wherein R¹ and R² may be bonded together to form a cyclic structure having 4 or more but 5 or less carbon atoms; and R⁵ and R⁷ each represent a substituent group selected from alkyl groups having 4 carbon atoms or less, ether groups having 4 carbon atoms or less, ester groups having 4 carbon atoms or less, and carbonate groups having 4 carbon atoms or less, and R⁶ is a substituent group selected from among hydrogen and a methyl group.

3. The semiconductor module according to claim 1, wherein the ionic liquid contains at least one anion selected from among PF₆⁻, [PF₃(C₂F₅)₃]⁻, [PF₃(CF₃)₃]⁻, BF₄⁻, [BF₂(CF₃)₂]⁻, [BF₂(C₂F₅)₂]⁻, [BF₃(CF₃)]⁻, [BF₃(C₂F₅)]⁻, [B(COOCOO)₂]⁻, CF₃SO₃⁻, C₄F₉SO₃⁻, [(CF₃SO₂)₂N]⁻, [(C₂F₅SO₂)₂N]⁻, [(CF₃SO₂)(C₄F₉SO₂)N]⁻, [(CN)₂N]⁻, [(CF₃SO₂)₃C]⁻, and [(CN)₃C]⁻.

4. The semiconductor module according to claim 3, wherein the anion contained in the ionic liquid is composed of one or more anions selected from among [(CF₃SO₂)₂N]⁻, [(C₂F₅SO₂)₂N]⁻, and [(CF₃SO₂)(C₄F₉SO₂)N]⁻.

5. The semiconductor module according to claim 1, wherein the negative electrode contains a titanium-containing metal composite oxide.

6. The semiconductor module according to claim 1, wherein the sealing resin is an epoxy resin.

7. The semiconductor module according to claim 6, wherein the epoxy resin is a cured product obtained by reaction of at least an organic compound having an epoxy group and an organic compound having an acid anhydride group.

8. The semiconductor module according to claim 1, wherein the separator is made of a resin selected from among polytetrafluoroethylene, polytetrafluoroethylene-perfluoroalkoxyethylene, polyhexafluoropropylene, polytetrafluoroethylene-hexafluoropropylene, polyethylene-tetrafluoroethylene, polyethyleneterephthalate, polyamide, polyimide, and cellulose.

9. The semiconductor module according to claim 1, wherein the insulating substrate is provided with a loop antenna.

10. A method for producing a battery-integrated semiconductor module, comprising:
forming a semiconductor device on an insulating substrate;
forming a nonaqueous electrolyte battery by laminating a positive electrode, a negative electrode, and a separator for separating the positive electrode and the negative electrode from each other in and/or on the insulating substrate and pouring a nonaqueous electrolyte containing an ionic liquid as a main component onto the positive electrode, the negative electrode, and the separator to impregnate the positive electrode, the negative electrode, and the separator with the nonaqueous electrolyte; and
sealing the semiconductor device and the nonaqueous electrolyte battery with a resin, wherein the nonaqueous electrolyte is in contact with the insulating substrate and the resin via any one of the positive electrode, the negative electrode, and the separator.
